(19) United States
(12) Patent Application Publication
(10) Pub. No.: US 2002/0143422 A1
(43) Pub. Date: Oct. 3, 2002

(54) Manufacturing apparatus, control method of manufacturing apparatus, control system of manufacturing apparatus, computer readable recording medium with control program of manufacturing apparatus recorded therein and control program of manufacturing apparatus

(76) Inventor: Shoji Seta, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/154,977

(22) Filed: May 28, 2002

Related U.S. Application Data
(63) Continuation-in-part of application No. PCT/JP00/06730, filed on Sep. 28, 2000.

(51) Int. Cl. G06F 19/00

(52) U.S. Cl. 700/104; 700/96; 700/108; 700/117

(57) ABSTRACT

There is disclosed a control system of a manufacturing apparatus, which controls a semiconductor manufacturing apparatus, comprising an interface which is connected to an exclusive-use circuit and which to transmits and receives information to and from the exclusive-use circuit, a processor which transmits at least one of recipe information and software for controlling the manufacturing apparatus to the manufacturing apparatus having an interface from the interface via the exclusive-use circuit, and a database which is connected to the processor and which stores at least one of the recipe information and software.

### CROSS REFERENCE TO RELATED APPLICATIONS

This is a Continuation Application of PCT Application No. PCT/JP00/06730, filed Sep. 28, 2000, which was not published under PCT Article 21(2) in English.

### BACKGROUND OF THE INVENTION

1. Field of the Invention

The present invention relates to a control method using a network to control manufacturing apparatuses such as a semiconductor manufacturing apparatus, a control system of the manufacturing apparatus, a computer readable recording medium with a control program of the manufacturing apparatus recorded therein, and the manufacturing apparatus controlled by these.

2. Description of the Related Art

An apparatus manufacturer of manufacturing apparatuses such as a semiconductor manufacturing apparatus heretofore delivers the manufactured apparatus to a purchaser, after manufacturing the manufacturing apparatus. For such manufacturing apparatuses, in recent years, a hardware configuration has been controlled by a computer, and an operation of the computer has been controlled by software, not hardware in the present circumstances.

When apparatuses of a manufacturing line of manufacturing apparatuses are started up, a malfunctioning apparatus is repaired, and software erroneously operates after hardware improvement, the apparatus manufacturer calls an engineer, and countermeasures are taken. This is because an engineer of the manufacturer generally having most knowledge on the manufacturing apparatus is suitable for performing maintenance on the manufacturing apparatus.

In general, the trouble of the manufacturing apparatus is checked by telephone, when the cause is found in the software. However, in the present circumstances where software and recipe of manufacturing apparatuses are complicated, it is very difficult to handle the trouble only by telephone. Moreover, when the engineer of the manufacturer is called, much time and money are required. Therefore, much time is required for complete the saving procedure for the trouble. As a result, production efficiency of the apparatus of the manufacturing apparatus drops.

Therefore, for example, when the manufacturing line of the manufacturing apparatus is started up, the manufacturer sends a large number of engineers to the manufacturing line, and an apparatus start-up operation is performed. Thereby, the time for starting up the apparatuses is little shortened. However, the number of engineers is small, and a sufficient number of engineers do not gather for the start-up in many cases. Furthermore, in order to start up a large number of manufacturing apparatuses, much time is required, and further, manual start-up mistakes are caused in many cases. This is mainly because the hardware configuration of the manufacturing apparatuses, and the software and recipe for controlling the hardware configuration have become complicated in recent years.

Furthermore, for example, when the manufacturing apparatuses are simultaneously started up in a plurality of factories, that is, when the manufacturing apparatuses as start-up objects are not centered in one place, such artificial mistake further easily happens.

Additionally, for example, when the same manufacturing apparatuses are used in a plurality of factories, the hardware configuration, software and recipe of the manufacturing apparatuses tend to be unified. However, in actuality, such unifying operations are difficult in the present situations. The recipe and software which are not unified among the factories in this manner cause various troubles. As a result, the production efficiency of devices by the manufacturing apparatuses deteriorates.

### BRIEF SUMMARY OF THE INVENTION

An object of the present invention is to provide a manufacturing apparatus which facilitates control of hardware, software and recipe of the manufacturing apparatus, and, as a result, enhances production efficiency of devices by manufacturing apparatuses, a control system of the manufacturing apparatus, and a computer readable recording medium in which a control program of the manufacturing apparatus is recorded.

According to a first aspect of the present invention, there is provided a control system of a manufacturing apparatus which controls the manufacturing apparatus via a communication network, the control system comprising: an interface which is connected to the communication network and which transmits and receives information to and from the communication network; a processor which is connected to the interface and which transmits at least one of recipe information and software to control the manufacturing apparatus to the manufacturing apparatus from the interface via the communication network; and storage means which is connected to the processor and which stores at least one of the recipe information and software.

According to another aspect of the present invention, there is provided a manufacturing apparatus comprising: a manufacturing unit; an interface which is connected to a communication network and which transmits and receives information to and from the communication network; a processor which is connected to the interface and which obtains at least one of software and recipe information to control the manufacturing unit from the interface via the communication network; and storage means, connected to the processor, for storing at least one of the recipe information and software.

According to the above-described configuration, the control system of the manufacturing apparatus can collectively transmit the software and recipe information to the manufacturing apparatus and start up the apparatus. Therefore, it is unnecessary to successively and separately install the software and recipe information in the respective manufacturing apparatuses. As a result, time for starting up the manufacturing apparatus is shortened, and the manufacturing apparatus can quickly be started up. Moreover, since the manufacturing apparatuses can be started up in a unified manner, artificial mistakes easily generated in separately starting up the respective manufacturing apparatuses remarkably decrease.

Moreover, the present invention relating to the apparatus is also established as the invention of a method of using the apparatus.

Furthermore, the present invention relating to the apparatus or the method is also established as a program for allowing a computer to execute a procedure according to the present invention (or for allowing the computer to function as means according to the present invention, or for allowing the computer to realize a function according to the present invention), or as a recording medium readable by the computer, in which the program is recorded.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing the total configuration of a control system of a manufacturing apparatus according to a first embodiment of the present invention.

FIGS. 2A and 2B are diagrams showing one example of a detailed configuration of a semiconductor manufacturing apparatus and manufacturer terminal according to the embodiment.

FIG. 3 is a diagram showing a timing chart of a first start-up operation of the semiconductor manufacturing apparatus according to the embodiment.

FIG. 4 is a diagram showing a timing chart of a second start-up operation of the semiconductor manufacturing apparatus according to the embodiment.

FIG. 5 is a drawing showing a timing chart of an operation for solving a trouble, when a trouble is generated in any semiconductor manufacturing apparatus according to the embodiment.

FIG. 6 is a schematic view showing the total configuration of a control system of the manufacturing apparatus according to a second embodiment of the present invention.

FIG. 7 is a schematic view showing the total configuration of the control system of the manufacturing apparatus according to a modification example of the present invention.

### DETAILED DESCRIPTION OF THE INVENTION

Respective embodiments of the present invention will be described hereinafter with reference to the drawings.

### First Embodiment

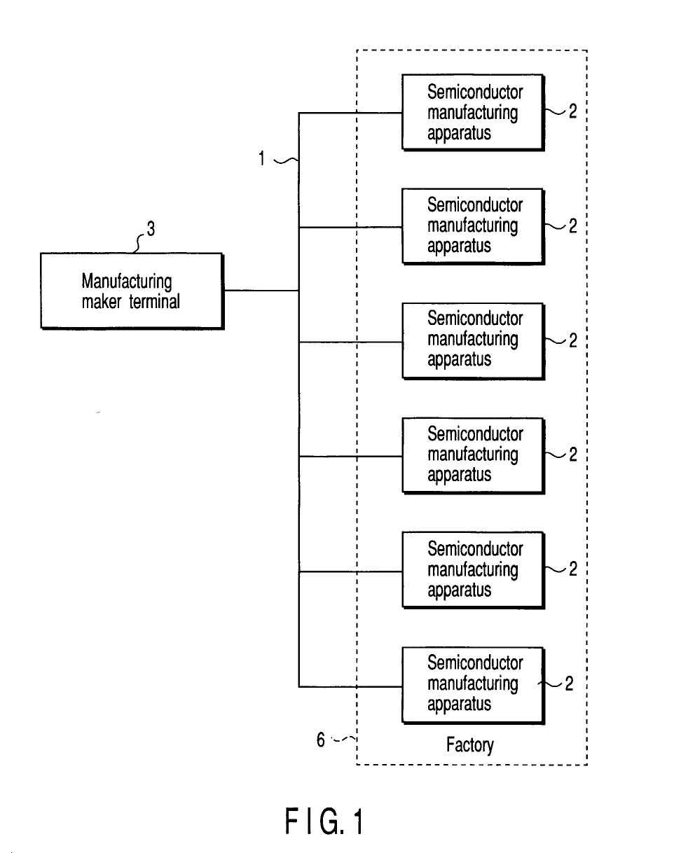

FIG. 1 is a schematic diagram showing the total configuration of a control system of manufacturing apparatuses according to a first embodiment of the present invention. The present embodiment has a mode in which the present system is applied in controlling semiconductor manufacturing apparatuses.

As shown in FIG. 1, a plurality of semiconductor manufacturing apparatuses 2 as objects to be controlled by the control system of the manufacturing apparatuses are connected to a manufacturer terminal 3 in which the semiconductor manufacturing apparatuses as objects to be controlled by the control system of the manufacturing apparatuses are sold, and maintained via an exclusive-use circuit 1. Moreover, the respective semiconductor manufacturing apparatuses 2 are disposed in the same factory 6.

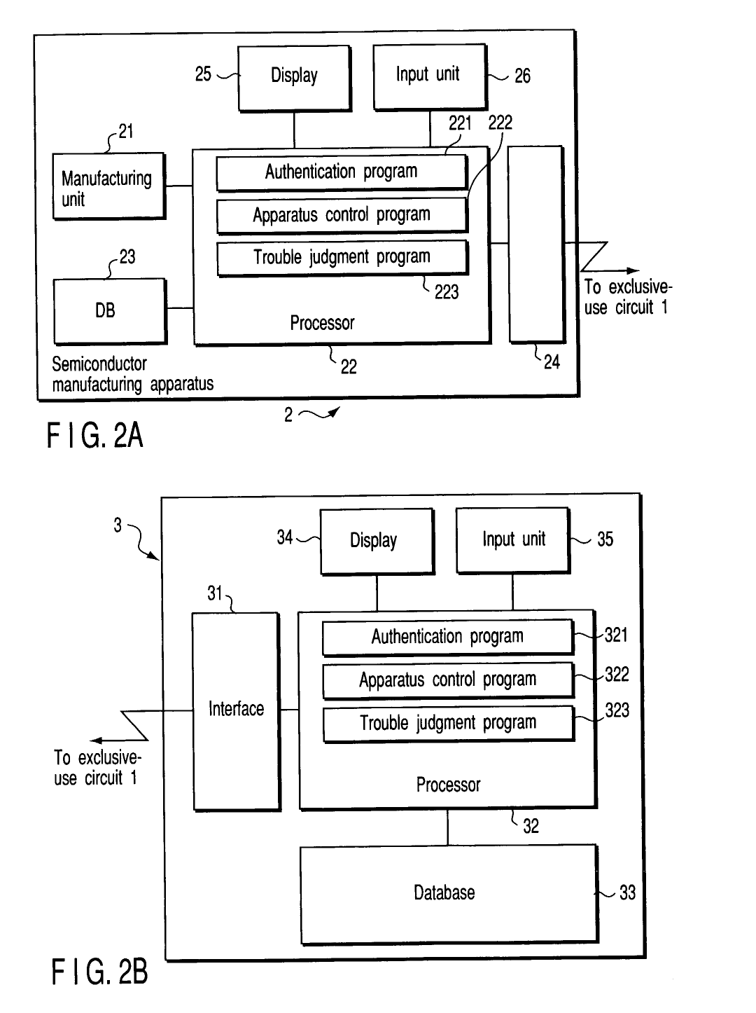

FIGS. 2A and 2B shows a diagram of one example of a detailed configuration of each semiconductor manufacturing apparatus 2 and manufacturer terminal 3. FIG. 2A shows the configuration of the semiconductor manufacturing apparatus 2, and FIG. 2B shows the configuration of the manufacturer terminal 3.

As shown in FIG. 2A, the semiconductor manufacturing apparatus 2 is comprised of a manufacturing unit 21, a processor 22 connected to the manufacturing unit 21, a database 23, an interface 24, a display 25 and an input unit 26 connected to the processor 22.

The manufacturing unit 21 is a portion having a mechanism for actually manufacturing devices, and is comprised mainly of hardware. One example includes a film forming mechanism, etching mechanism, ashing mechanism, chemical mechanical polishing (CMP) mechanism, resist application mechanism, developing mechanism, heating/cooling mechanism, and the like.

The processor 22 uses a built-in program to control the manufacturing unit 21 based on software and recipe information stored in the database 23, or based on the recipe information inputted via the input unit 26. Moreover, the processor 22 also has a function for controlling transmission/reception of the interface 24 during transmission/reception of the information with the manufacturer terminal 3 via the exclusive-use circuit 1. The recipe information is information indicating, for example, processing procedures of the respective components constituting, for example, the manufacturing unit 21, or processing conditions.

Moreover, the input unit 26 sends information inputted by an operator of the manufacturing apparatus, and the like to the processor 22, and can control the operation of the manufacturing apparatus 2 based on the inputted information. Examples of the input unit 26 include a keyboard, a mouse, and the like.

In the display 25, the operation, trouble situation, and the like of the manufacturing apparatus 2 are displayed. When the operator of the manufacturing apparatus, and the like see the display 25, the operation situation, and the like of the manufacturing apparatus 2 can be checked.

The processor 22 includes an authentication processor 221 for performing authentication in trying to control the manufacturing apparatus 2, an apparatus control processor 222 for controlling the manufacturing apparatus based on predetermined software and recipe information, and a trouble judgment processor 223 for determining a cause of a trouble generated in the manufacturing apparatus based on an operation content of the manufacturing apparatus.

Moreover, in the database 23, software for controlling the manufacturing unit 21, and recipe information which is given for each manufacturing condition and which gives a parameter for controlling the manufacturing unit 21 on predetermined conditions are stored.

As shown in FIG. 2B, the manufacturer terminal 3 is comprised of an interface 31, a processor 32 connected to the interface 31, a database 33, a display 34 and an input unit 35 connected to the processor 32. The interface 31 has a function for transmitting/receiving information to/from the semiconductor manufacturing apparatuses 2 via the exclusive-use circuit 1.

When the semiconductor manufacturing apparatuses 2 are started up, the processor 32 extracts the software and recipe information for controlling the semiconductor manufacturing apparatuses 2 from the database 33, and can transmit this to the semiconductor manufacturing apparatuses 2, and remotely operate the semiconductor manufacturing apparatus 2. The processor 32 includes an authentication program 321, apparatus control program 322, and trouble judgment program 323.

Moreover, the input unit 35 is a portion via which information for allowing the manufacturing apparatuses to execute various types of processing by the processor 32 is inputted, and the information inputted via the input unit 35 is sent to the processor 32. Examples of the input unit 35 include a keyboard, mouse, and the like.

In the display 34, contents of various types of the processing executed using the manufacturer terminal 3 are displayed. A manufacturer person in charge sees the display 34, and can thereby check the processing content in the manufacturer terminal 3.

The operation of the control system of the manufacturing apparatuses shown in FIG. 1 will next be described. Additionally, unless especially mentioned in the following embodiment, each operation is performed by transmission/reception of the information via the exclusive-use circuit 1.

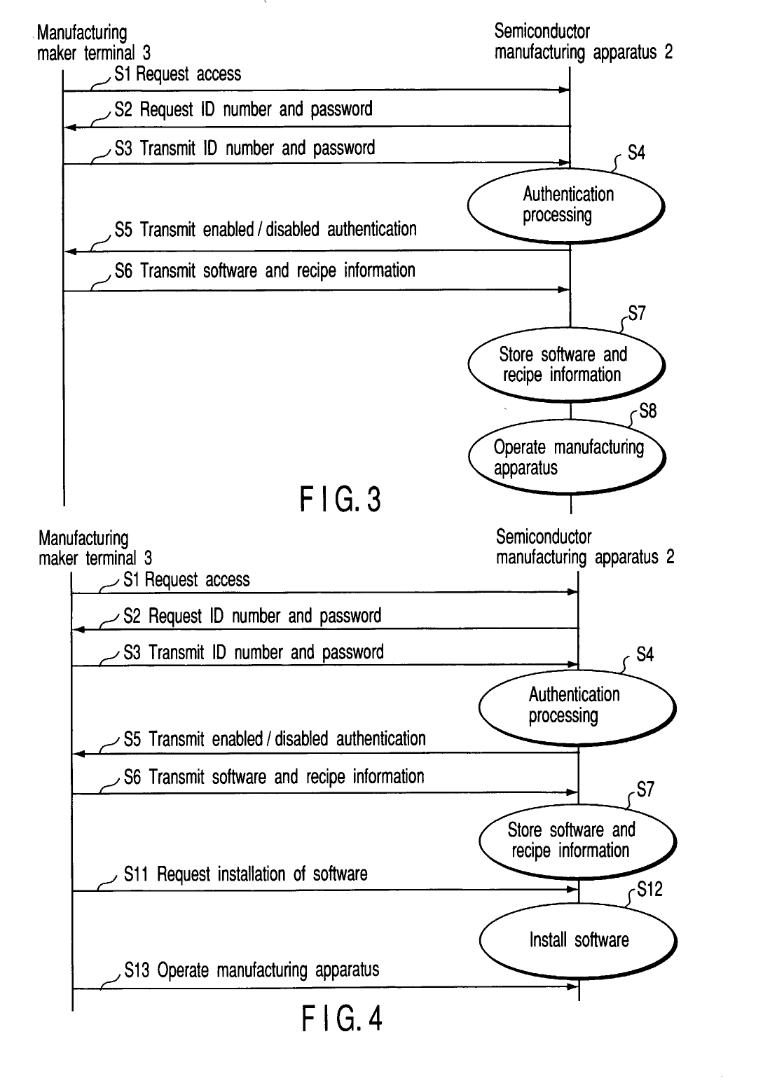

First, a first apparatus start-up operation will be described with reference to the timing chart shown in FIG. 3. Additionally, there are a plurality of semiconductor manufacturing apparatuses 2 which transmit/receive information with the manufacturer terminal 3. The same also applies in the following example.

As shown in FIG. 3, first the manufacturer terminal 3 makes a request for access to a plurality of semiconductor manufacturing apparatuses 2 (s1). Each semiconductor manufacturing apparatus 2 requires an ID number and password of the manufacturer terminal 3 (s2). The manufacturer terminal 3 uses the input unit 35 to input the ID number and password. Of course, the ID number and password may be stored for each semiconductor manufacturing apparatus 2 requiring the access beforehand in the database 33, and the information stored in the database 33 may be read out.

The inputted ID number and password are sent to the processor 32. The processor 32 transmits the ID number and password to each semiconductor manufacturing apparatus 2 via the interface 31 (s3). The authentication processor 221 of each semiconductor manufacturing apparatus 2 which receives the ID number and password reads out the ID number and password of the manufacturer terminal 3 stored beforehand in the database 23, and collates the read ID number and password with the received ID number and password (s4). By the collation, when the ID numbers and passwords mutually agree, enabled authentication is judged. Moreover, with disagreement, disabled authentication is judged. The information indicating the enabled/disabled authentication is transmitted to the manufacturer terminal 3 from each semiconductor manufacturing apparatus 2 (s5).

When the manufacturer terminal 3 receives the information indicating the enabled authentication, the software and recipe information for each semiconductor manufacturing apparatus 2 is transmitted to each semiconductor manufacturing apparatus 2 (s6). The semiconductor manufacturing apparatus 2 receives the software and recipe information, and stores the received software and recipe information in the database 23 (s7). When the manufacturer terminal 3 receives the information indicating the disabled authentication, the connection by the manufacturer terminal 3 ends.

The manufacturer terminal 3 which completes the transmission of the software and recipe information completes the connection to the exclusive-use circuit 1. On the other hand, on the side of each semiconductor manufacturing apparatus 2, the operator of the manufacturing apparatus 2 uses, for example, the input unit 26 and checks the display 25 to read out the software and recipe information stored in the database 23, and issues an operation command based on the software and recipe information. For example, the operation command is issued by using the input unit 26 to press an operation panel displayed in the display 25. Upon receiving the operation command, the apparatus control processor 222 in the processor 22 operates the manufacturing unit 21 based on the read-out software and recipe information (s8). Thereby, the apparatus start-up is completed.

Additionally, with the apparatus start-up shown in FIG. 3, when the semiconductor manufacturing apparatus 2 does not have both the software and recipe information, or the common software and recipe information are to be provided, both of these are transmitted from the manufacturer terminal 3. However, when the software is already installed in the semiconductor manufacturing apparatus 2, that is, when the manufacturing unit 21 is incorporated so as to be controllable, only the recipe information may be transmitted. Moreover, when the operator of the manufacturing apparatus generates the recipe information, and controls or manually operates the manufacturing unit 21 based on the recipe information, only the software may be transmitted.

Moreover, when the apparatus control processor 222 of the processor 22 on the semiconductor manufacturing apparatus 2 side receives the software and recipe information, the software is preferably installed so as to be automatically able to start up.

In this manner, when the software or the recipe information is collectively transmitted to a plurality of semiconductor manufacturing apparatuses via the exclusive-use circuit 1, and the manufacturing apparatuses are started up at the same time, the respective semiconductor manufacturing apparatuses can be started up in a unified manner. Therefore, it is unnecessary to successively install the software and recipe information in the respective semiconductor manufacturing apparatuses 2. Moreover, since the operator can collectively transmit the software and recipe information necessary for starting up the apparatuses to the respective semiconductor manufacturing apparatuses 2, the time for installment in each semiconductor manufacturing apparatus 2 is reduced, and the apparatus can quickly be started up.

Moreover, since the apparatuses are started up in a unified manner, operator's artificial mistakes made in starting up the apparatus one by one are remarkably reduced. Moreover, the recipe, software, and hardware of the manufacturing apparatuses in the whole factory can easily be unified. As a result, the same product can easily be manufactured in the same factory.

A second apparatus start-up operation will next be described with reference to the timing chart shown in FIG. 4.

The manufacturer terminal 3 sends the access request to the semiconductor manufacturing apparatus 2, further provides the ID number and password, and is judged that the authentication is to be enabled, and transmits the software and recipe information to the semiconductor manufacturing apparatus 2. This process is similar to that of the first apparatus start-up (s1) to (s6).

After the manufacturer terminal 3 provides the software and recipe information to each semiconductor manufacturing apparatus 2 so as to bring each manufacturing unit 21 into a controllable state, the terminal 3 issues a request for installation of the software to each semiconductor manufacturing apparatus 2 (s11). Upon receiving this request, the apparatus control processor 222 in each semiconductor manufacturing apparatus 2 installs the software (s12). Subsequently, on the manufacturer terminal 3 side, the operator uses the input unit 35 to control the manufacturing unit 21. In this case, the information inputted by the operator agrees with the information inputted using the input unit 226 in operating the manufacturing unit 21 on the semiconductor manufacturing apparatus 2 side. That is, in a position remote from the semiconductor manufacturing apparatuses 2, the manufacturer terminal 3 is used to control the manufacturing units 21 based on the software and recipe information transmitted beforehand (s6).

Thereby, the operation of the manufacturing units 21 is similarly to that using the input units 26 on the semiconductor manufacturing apparatus 2 side. Thereby, apparatus start-up is completed.

In this manner, in the example of the second apparatus start-up, a similar effect to that of the example of the first apparatus start-up, and an effect which cannot be obtained in the first example is further produced. That is, since the semiconductor manufacturing apparatuses 2 are operated on the manufacturer terminal 3 side, the operator on duty who starts up the apparatuses can start up the apparatuses from a remote area, without going to the factory 6 where the semiconductor manufacturing apparatuses 2 are disposed. Therefore the commuting time to the factory 6, and the like are reduced, and the apparatuses can quickly be started up.

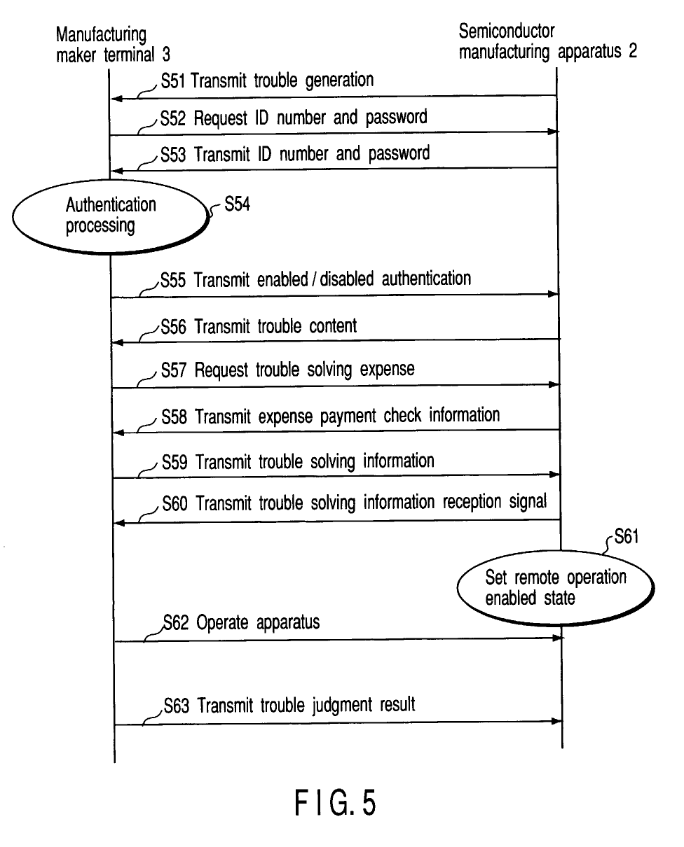

An operation for solving the trouble will next be described with reference to a timing chart in FIG. 5. The trouble is generated in any one of the semiconductor manufacturing apparatuses, when the semiconductor manufacturing apparatuses 2 are used to manufacture semiconductor devices according to the first or second apparatus start-up operation.

First, the operator who operates the semiconductor manufacturing apparatuses 2 and finds any trouble uses the input unit 26 of the corresponding semiconductor manufacturing apparatus 2 to transmit the information indicating the generation of the trouble to the manufacturer terminal 3 (s51).

Of course, the apparatus control processor 222 of the semiconductor manufacturing apparatus 2 may detect the trouble, and the information indicating the generation of the trouble may automatically be transmitted to the manufacturer terminal 3 based on a detected trouble detection signal. Moreover, any person on the manufacturer terminal 3 side may be notified of the occurrence of the trouble using other means such as telephone, FAX, and electronic mail without using the exclusive-use circuit 1.

In this case, the manufacturer terminal 3 requires the ID number and password in order to judge whether or not the customer's semiconductor manufacturing apparatus 2 is a pre-registered manufacturing apparatus (s52). Upon receiving this request, the operator of the manufacturing apparatuses uses the input unit 26 to input the ID number and password. The inputted ID number and password are transmitted to the manufacturer terminal 3 side via the interface 24 (s53). The ID number and password are received by the interface 31 of the manufacturer terminal 3. The ID number and password received by the interface 31 are sent to the processor 32, and the enabled/disabled authentication is judged by the authentication program 321 (s54). Concretely, the authentication program 321 in the processor 32 reads out the ID number and password of the semiconductor manufacturing apparatus 2 pre-stored in the database 33, and collates these with the received ID number and password. By the collation, when both the ID number and the password agree with the received ones, the authentication is judged to be enabled. Moreover, upon disagreement, the authentication is judged to be disabled. The information indicating the enabled/disabled authentication is transmitted to the semiconductor manufacturing apparatuses 2 from the manufacturer terminal 3 (s55).

When the information indicating the enabled authentication is received by the semiconductor manufacturing apparatuses 2, the information indicating the content of the trouble is transmitted to the manufacturer terminal 3 (s56). The information indicating the content of the trouble may actually include the recipe information in a situation in which the trouble actually occurs and the software for use. For the transmission of the information indicating the content of the trouble, for example, when the processor 22 receives a predetermined warning message during the operation of the apparatus, the information may automatically be generated in response to the message, or the operator operating the manufacturing apparatuses 2 may input the trouble content grasped by the operator via the input unit 26.

When the information indicating the content of the trouble is received by the manufacturer terminal 3, the content of the trouble is displayed in the display 34. A person on the manufacturer side confirms the content of the trouble displayed in the display 34, calculates a trouble solving expense in accordance with the content of the trouble, and makes a trouble solving expense request (s57). When the manufacturer terminal 3 makes the trouble solving expense request, the trouble solving expense is displayed in the display 25 of the semiconductor manufacturing apparatus 2, and it is prompted to be selected whether or not to pay the expense. Concretely, for example, when an OK panel displayed in the display 25 is pressed, an expense payment check signal is transmitted to the manufacturer terminal 3 (s58). When a cancel panel is pressed, an expense non-payment check signal is transmitted to the manufacturer terminal 3.

The manufacturer terminal 3 stores a bank account number on the manufacturing apparatus side, and the like beforehand in the database 33 for each semiconductor manufacturing apparatus 2 or each factory 6, and connects to a charging server (not shown) based on the bank account number, so that the expense may automatically be paid via the bank account on the manufacturing apparatus side.

On the other hand, when the manufacturer terminal 3 receives the expense non-payment check signal, the connection by the semiconductor manufacturing apparatus 2 ends.

The operator on the manufacturer terminal 3 side who ends the charging judges whether the trouble is generated by hardware, software, or the setting of the recipe. Moreover, when the content of the trouble can be specified, for example, trouble solving information is inputted into the input unit 35 in accordance with the specified trouble and thereby generated. Furthermore, the interface 31 is used to transmit the trouble solving information to the semiconductor manufacturing apparatus 2 (s59). The trouble solving information may be, for example, a message in which the trouble is specified, or the software or the recipe information for use on the semiconductor manufacturing apparatus 2 side.

More concretely, for example, it is judged that it is difficult to manufacture according to the recipe for the hardware of the manufacturing apparatus, and then new software for executing the difficult recipe is transmitted. Moreover, when the hardware and recipe are judged to have no trouble, it is judged that the software has a trouble, and the new software is transmitted. Additionally, the judgment example described herein is only one example, and any trouble content is relevant.

The processor 32 of the semiconductor manufacturing apparatus 2 which receives the trouble solving information transmits a trouble solving information reception signal for transmitting the reception of the trouble solving information to the manufacturer terminal 3 (s60), and sets the semiconductor manufacturing apparatuses 2 on the manufacturer terminal 3 side in an operable state (s61). This setting is preferably automatically performed by the processor 22 confirming that the trouble solving information reception signal has been transmitted. Of course, when the semiconductor manufacturing apparatus 2 is operated on the manufacturer terminal 3 side, an authentication processing is securely performed as shown in (s2) to (s5) of FIG. 3, and the authentication is performed. Only in a case the authentication is judged to be enabled, the setting becomes possible.

On the manufacturer terminal 3 side having judged that the authentication is to be enabled, the operator remotely operates the semiconductor manufacturing apparatuses 2 in a position remote from the semiconductor manufacturing apparatuses 2 (s62). The operation information of the semiconductor manufacturing apparatuses 2 is displayed in the display 34 of the semiconductor manufacturing apparatus 2, and similarly displayed in the display 25 of the manufacturer terminal 3.

The operator performing the remote operation uses the display 25 to check whether or not the semiconductor manufacturing apparatuses 2 normally operate. If it is judged that the apparatuses normally operate, it is then judged that the trouble has been solved, and the information indicating that the apparatus normally operates is transmitted as a trouble judgment result. Of course, it is considered not only in a case that the trouble is solved, but also in a case that the trouble can be specified without solving the trouble. In this case, the trouble judgment result on which the trouble is specified is transmitted (s63). The trouble judgment result may manually be generated, but may preferably be judged by the trouble judgment program 323 for automatically judging the trouble in accordance with the operation state of the remote operation.

Moreover, the trouble judgment processor 223 similar to the trouble judgment program 323 on the manufacturer terminal 3 side is also disposed in the processor 22 on the semiconductor manufacturing apparatus 2 side, and the judgment result obtained by judging the trouble may be transmitted to the manufacturer terminal 3. Furthermore, the trouble judgment program may be disposed on either the semiconductor manufacturing apparatus 2 side or the manufacturer terminal 3 side.

Such a trouble solving operation is performed, so that the trouble can easily and quickly be solved without sending the operator skilled in the apparatuses to the factory 6 from the manufacturer side.

Additionally, when the semiconductor manufacturing apparatuses 2 are connected to the manufacturer terminal 3 side, the manufacturer terminal 3 requests the ID number and password and performs the authentication processing, but the terminal may be connected to the apparatus 2 side without performing the authentication processing.

### Second Embodiment

The present invention relates to a modification example of the first embodiment. The present embodiment relates to an embodiment in which there are not a plurality of semiconductor manufacturing apparatuses 2 in the same factory.

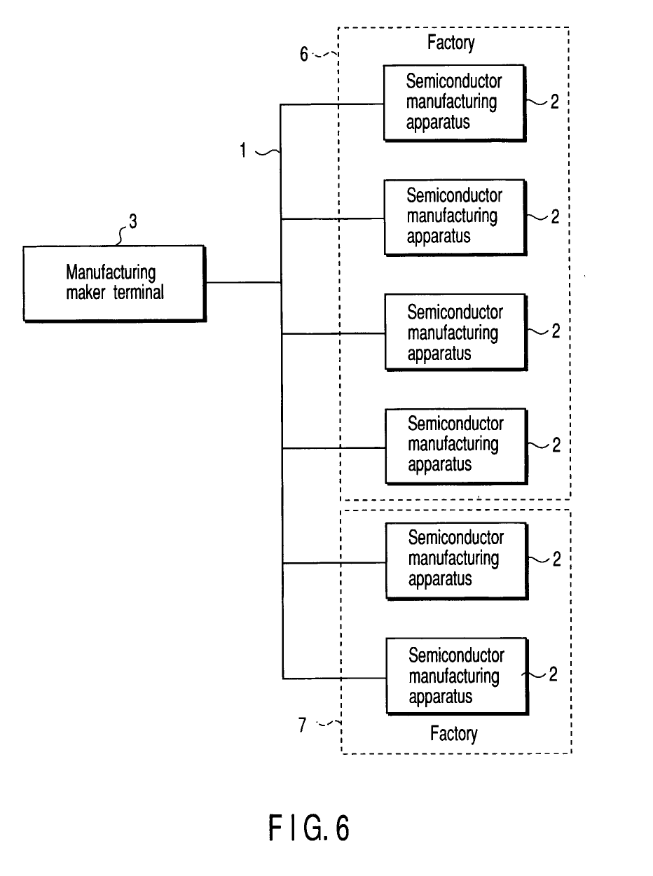

FIG. 6 is a schematic view showing the total configuration of the control system of the manufacturing apparatus according to the present embodiment. As shown in FIG. 6, a configuration in which the manufacturer terminal 3 and the plurality of semiconductor manufacturing apparatuses 2 are connected via the exclusive-use circuit 1 is similar to that of FIG. 1, but the semiconductor manufacturing apparatuses 2 are arranged in different factories 6 and 7. In one of the corresponding examples, the factory 6 is inside the country, and a factory 7 is in another country.

In this case, the apparatus start-up or the solving of the trouble is performed similarly as the first embodiment, and thereby the effect similar to that of the first embodiment is produced. Moreover, in the example shown in FIG. 6, usually the operator skilled in the apparatuses on the manufacturer side needs to visit the respective factories 6 and 7, when the troubles are generated in the factories 6 and 7 at the same time. On the other hand, according to the present embodiment, the trouble can be solved on the manufacturer terminal 3 side. Therefore, the trouble can easily and quickly be solved. Moreover, even for the start-up of the apparatuses, the operator skilled in the apparatus can use the manufacturer terminal 3 to easily and quickly start up the apparatus on the manufacturer side. Therefore, the operator does not have to go abroad in order to start up the apparatuses. Of course, the same can apply even to the start-up, maintenance, and trouble processing of the manufacturing apparatuses 2 in three or more factories.

The present invention is not limited to the above-described embodiments.

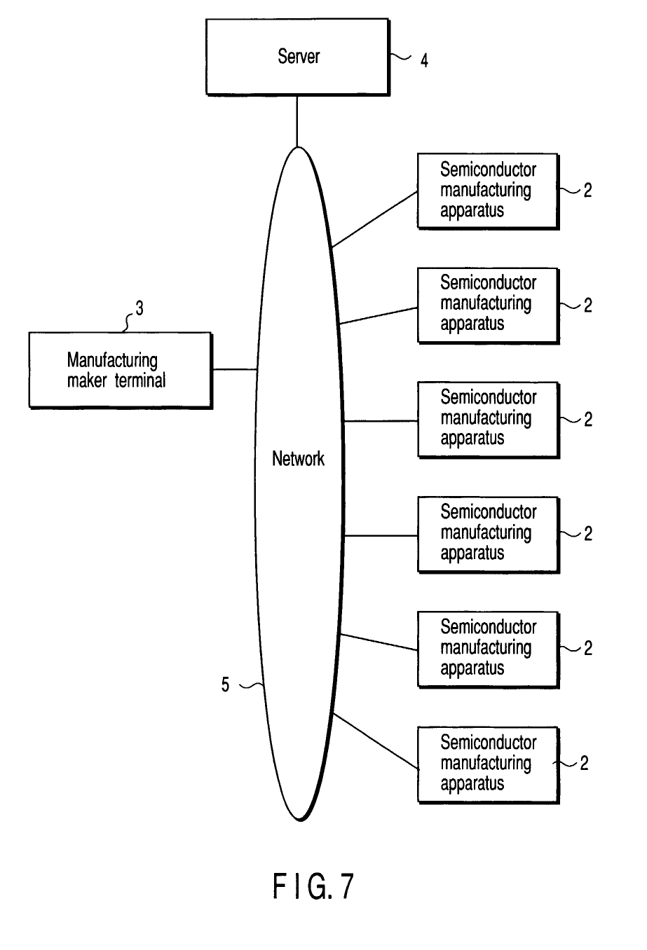

For example, as shown in FIG. 7, the control system may have a configuration in which the semiconductor manufacturing apparatuses 2 and manufacturer terminal 3, and a server 4 are connected to a network 5. In this case, the semiconductor manufacturing apparatuses 2 and manufacturer terminal 3 transmit/receive the information via the network 5, and the apparatuses 2 and terminal 3 can access the server 4 to transmit/receive the information via the server 4. Examples of the network 5 include the Internet, and the like, and the manufacturer terminal 3 uses a browser to be connected to the Internet.

Moreover, the example in which the present invention is applied to the control of the semiconductor manufacturing apparatuses has been described, but this is not limited. For example, it is possible to provide the recipe of the apparatuses, provide software, solve the trouble, and perform the maintenance of the apparatuses without any mistake in any manufacturing field of apparatuses such as a petroleum plant apparatus, food manufacturing apparatus, clothes manufacturing apparatus, and medicine manufacturing apparatus.

Furthermore, as the charging processing during the trouble occurrence, the manufacturer terminal side is notified that the trouble has occurred, and subsequently the solving expense is calculated in accordance with the content of the trouble. However, for example, when the charging processing is performed by an annual contract, and the like, the charging processing for each generated trouble can be omitted.

Additionally, in the above-described embodiments, the example in which the manufacturer terminal 3 is used to control the plurality of the same type of semiconductor manufacturing apparatuses 2 has been described above, but a plurality of different semiconductor manufacturing apparatuses may be controlled. In this case, different recipe information and software are transmitted for the respective different manufacturing apparatuses.

As described above, the present invention is effective in the fields of manufacturing apparatuses, a control system of the manufacturing apparatuses for controlling the manufacturing apparatuses, and a control method for the manufacturing apparatuses using the control system of the manufacturing apparatuses, and further in the field of a recording medium readable by a computer, in which a control program for controlling the manufacturing apparatuses is recorded.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A control system of a manufacturing apparatus which controls the manufacturing apparatus via a communication network, said control system comprising:
an interface which is connected to the communication network and which transmits and receives information to and from the communication network;
a processor which is connected to said interface and which transmits at least one of recipe information and software to control the manufacturing apparatus to the manufacturing apparatus from the interface via the communication network; and
storage means which is connected to said processor and which stores at least one of said recipe information and software.

2. The control system of the manufacturing apparatus according to claim 1, wherein said processor includes apparatus control means for controlling said manufacturing apparatus via said communication network.

3. The control system of the manufacturing apparatus according to claim 1, wherein said processor includes judgment means for judging a cause of the trouble based on trouble information received from said manufacturing apparatus via said interface.

4. The control system of the manufacturing apparatus according to claim 1, wherein the control system of said manufacturing apparatus is connected to a plurality of said manufacturing apparatuses via said communication network.

5. A manufacturing apparatus comprising:
a manufacturing unit;
an interface which is connected to a communication network and which transmits and receives information to and from the communication network;
a processor which is connected to said interface and which obtains at least one of software and recipe information to control said manufacturing unit from the interface via the communication network; and
storage means, connected to said processor, for storing at least one of said recipe information and software.

6. The manufacturing apparatus according to claim 5, wherein said processor includes apparatus control means for setting said manufacturing unit to be controllable based on a signal from said communication network.

7. The manufacturing apparatus according to claim 5, wherein said processor includes judgment means for judging a cause of a trouble of said manufacturing apparatus based on an operation content of said manufacturing unit obtained by controlling said manufacturing unit.

8. A control method of a manufacturing apparatus comprising:
making a connection request to the manufacturing apparatus via a communication network;
transmitting identification information in response to a request for the identification information from said manufacturing apparatus; and
transmitting at least one of recipe information and software to control said manufacturing apparatus.

9. The control method of the manufacturing apparatus according to claim 8, further comprising:
transmitting a control signal via the communication network to said manufacturing apparatus to control said manufacturing apparatus after transmitting at least one of said recipe information and the software.

10. The control method of the manufacturing apparatus according to claim 8, further comprising:
generating a trouble judgment result to specify a cause of the trouble based on information which specifies a content of the trouble generated in said manufacturing apparatus, and transmitting the trouble judgment result to said manufacturing apparatus.

11. The control method of the manufacturing apparatus according to claim 8, further comprising:
transmitting a control signal to said manufacturing apparatus to control said manufacturing apparatus via the communication network based on information which specifies the content of the trouble generated in said manufacturing apparatus.

12. The control method of the manufacturing apparatus according to claim 8, further comprising:
transmitting at least one of the recipe information and the software for solving the trouble based on information which specifies a content of a trouble generated in said manufacturing apparatus.

13. The control method of the manufacturing apparatus according to claim 8, further comprising:
transmitting at least one of the recipe information and the software for solving the trouble based on information which specifies a content of a trouble generated in said manufacturing apparatus,
wherein at least one of the recipe information and the software for solving said trouble to said manufacturing apparatus is transmitted when expense information for solving the trouble is presented to said manufacturing apparatus, and information indicating determination of payment of an expense for solving said trouble is received from said manufacturing apparatus.

14. The control method of the manufacturing apparatus according to claim 8, wherein a plurality of said manufacturing apparatuses are disposed, and
transmission of said connection request, and said identification information and transmission of at least one of said recipe information and the software are performed with respect to said plurality of manufacturing apparatuses.

15. A control method of a manufacturing apparatus comprising a manufacturing unit, a processor to control the manufacturing unit, and an interface which is connected to the processor and which transmits and receives the information to and from a communication network, said method comprising:
receiving at least one of software and recipe information to control the manufacturing apparatus from said communication network via said interface; and
controlling said manufacturing apparatus based on at least one of said received software and the recipe information.

16. The control method of the manufacturing apparatus according to claim 15, further comprising:
controlling said manufacturing unit based on a control signal obtained from said communication network via said interface.

17. The control method of the manufacturing apparatus according to claim 15, wherein said processor comprises:
detecting a trouble of said manufacturing apparatus based on an operation content of said manufacturing unit controlled based on at least one of said received software and recipe information;
transmitting a content of said detected trouble via the communication network, and prompting presentation of at least one of the recipe information and software for solving the trouble; and
operating said manufacturing unit based on at least one of said presented recipe information and software.

18. The control method of the manufacturing apparatus according to claim 15, wherein said processor comprises:
detecting a trouble of said manufacturing apparatus based on an operation content of said manufacturing unit controlled based on at least one of said received software and the recipe information;
transmitting a content of said detected trouble via the communication network, and prompting presentation of at least one of the recipe information and software for solving the trouble;
operating said manufacturing unit based on at least one of said presented recipe information and software; and
judging a cause of said trouble based on an operation content of said manufacturing unit.

19. A computer readable recording medium in which a control program of a manufacturing apparatus is recorded to realize:
a function to cause the manufacturing apparatus including receiving unit to request connection via a communication network;
a function to cause to transmit identification information in accordance with request of the identification information form the receiving unit; and
a function to cause to transmit at least one of recipe information and software to control the manufacturing apparatus.

20. A computer readable recording medium in which a program for controlling a manufacturing apparatus comprising a manufacturing unit, a processor to control the manufacturing unit, and an interface connected to the processor to transmit/receive information with a communication network is recorded to realize:
a function to cause to receive at least one of software and recipe information to control the manufacturing apparatus from said communication network via said interface; and
a function to cause to control said manufacturing apparatus based on at least one of said software and recipe information.
